(19) United States
(12) Patent Application Publication
(10) Pub. No.: US 2026/0029024 A1
(43) Pub. Date: Jan. 29, 2026

(54) BEARING FOR A VEHICLE SUSPENSION

(71) Applicant: AKTIEBOLAGET SKF, GOTEBORG (SE)

(72) Inventors: Minggang MAO, Shanghai (CN); Hanshu HUANG, Shanghai (CN); Hui ZHOU, Shanghai (CN); Naijin SHI, Kunshan (CN)

(21) Appl. No.: 19/263,878

(22) Filed: Jul. 9, 2025

(30) Foreign Application Priority Data
Jul. 26, 2024 (CN) 202421786882.4

(51) Int. Cl. F16C 33/78; F16C 19/10

(52) U.S. Cl. CPC F16C 33/7823; F16C 19/10; F16C 2326/05

(57) ABSTRACT

A bearing for a vehicle suspension includes an upper housing having a radial upper flange with an upper recess, a lower housing having a radial lower flange with a lower recess, an upper ring disposed in the upper recess that has an upper raceway surface, and a lower ring disposed in the lower recess that has a lower raceway surface. A plurality of balls is disposed between the upper raceway surface and the lower raceway surface. Each of the balls contacts the upper raceway surface at a first point and at a second point and the first point and second point are angularly spaced by a first angle. Each of the plurality of balls contacts the lower raceway surface at a third point and at a fourth point, and the third point and fourth point are angularly spaced by a second angle.

### CROSS-REFERENCE

This application claims priority to Chinese patent application no. 202421786882.4 filed on Jul. 26, 2024, the contents of which are fully incorporated herein by reference.

### TECHNOLOGICAL FIELD

The present disclosure relates to a bearing for a vehicle suspension.

### BACKGROUND

Bearings are widely used in various devices and equipment, and the structure and performance of bearings vary greatly depending on the scenarios in which the bearings are used.

Vehicle suspension plays an important role in vehicle performance and comfort. A vehicle suspension comprises a number of components, such as bearings mounted on an air spring of the vehicle suspension. The bearing has a specialized configuration, comprising upper and lower housings nested in an axial direction (the axial direction is generally along the vertical direction with respect to the normal orientation of the vehicle), and there are means to facilitate the relative rotation between the two housings.

With a rapid development of automotive industry, comfort and space are more concerned than before. This requires miniaturization of many vehicle components, and therefore, there is also a need in the art for bearings for air springs to be compact along the axial direction.

One solution in the prior art uses a sliding piece to achieve relative rotation between the upper housing and the lower housing. The sliding piece has an annular structure with a rectangular interface, usually plastic, and is in sliding contact with the upper housing and the lower housing. However, although this solution reduces the axial height, its high friction torque, low stiffness and poor load capacity make it difficult to meet the requirements of air springs for bearings in automobile suspensions.

### SUMMARY

Therefore, there is a need in the art for a bearing that is compact along the axial direction, and meanwhile, preferably capable of withstanding large loads.

In response to the above-mentioned problems and needs, the present disclosure proposes a new technical solution, which solves the above problems and brings other technical effects by adopting the following technical features.

The present disclosure provides a bearing, comprising: an upper housing having a radial upper flange with an upper recess; a lower housing having a radial lower flange with a lower recess; an upper ring disposed in the upper recess and having an upper raceway; a lower ring disposed in the lower recess and having a lower raceway; and a rolling element disposed between the upper raceway and the lower raceway.

Preferably, the rolling element is a ball, which is in symmetric two-point contact with the upper raceway with respect to an axis passing through the center of the ball along the axial direction, and in symmetric two-point contact with the lower raceway with respect to an axis passing through the center of the ball along the axial direction; preferably, the two contact points between the ball and the upper raceway are symmetrical to the two contact points between the ball and the lower raceway with respect to a plane passing through the center of the ball and perpendicular to the axial direction.

Preferably, the included angle between the connecting lines, which connect the center of the ball and the two contact points of the ball with the upper raceway, is 90°±30° and/or the included angle between the connecting lines, which connect the center of the ball and the two contact points of the ball with the lower raceway, is 90°±30°.

Preferably, two surfaces of the upper raceway contacting the ball are formed into curved surfaces, and the included angle between the tangent planes respectively passing through the contact points on the two curved surfaces is 90°±30° or two surfaces of the upper raceway contacting the ball are formed into flat surfaces, and the included angle between the flat surfaces is 90°±30°.

Preferably, two surfaces of the lower raceway contacting the ball are formed into curved surfaces, and the included angle between the tangent planes respectively passing through the contact points on the two curved surfaces is 90°±30° or two surfaces of the lower raceway contacting the ball are formed into flat surfaces, and the included angle between the flat surfaces is 90°±30°.

Preferably, the ratio of the diameter of the ball to the height between the upper surface of the upper housing and the lower surface of the lower housing is 1:5 to 2:3.

Preferably, the upper ring is a metal ring, and the upper housing is made of plastic material and is fixedly connected with the upper ring and/or the lower ring is a metal ring, and the lower housing is made of plastic material and is fixedly connected with the lower ring.

Preferably, the upper housing further comprises an axial part with a protrusion, and the lower housing further comprises an axial part with a recess so that in the assembled state of the bearing, the protrusion is placed in the recess to suppress the relative movement between the upper housing and the lower housing; or the upper housing further comprises an axial part with a recess, and the lower housing further comprises an axial part with a protrusion, so that in the assembled state of the bearing, the protrusion is placed in the recess, to suppress the relative movement between the upper housing and the lower housing along the axial direction.

Preferably, the radial upper flange further comprises an upper annular wall extending axially downward, and the radial lower flange further comprises a lower annular wall extending axially upward, wherein the lower annular wall is located radially inwardly relative to the upper annular wall, or the lower annular wall is located radially outwardly relative to the upper annular wall.

Preferably, the bearing further comprises a seal disposed between the upper annular wall and the lower annular wall, wherein the seal is fixed to one of the upper annular wall and the lower annular wall and comprises at least one sealing lip extending toward and contacting the other one of the upper annular wall and the lower annular wall.

The present disclosure adopts an unconventional bearing design and thereby realizes not only an axial compact bearing structure without sacrificing load capacity of the bearing, but also provides more optimal force-bearing performance along axial and radial directions.

### BRIEF DESCRIPTION OF THE DRAWINGS

FIG. 1 is a cross-sectional view of a bearing according to an embodiment of the present disclosure.

FIG. 2 is an enlarged view of region A in FIG. 1.

FIG. 3 is a sectional view of a rolling element between two raceways according to an embodiment of the present disclosure.

FIG. 4 is a sectional view of a sealing structure according to an embodiment of the present disclosure.

FIG. 5 schematically illustrates a relationship between the contact angle and the containment angle in a simplified view.

### DETAILED DESCRIPTION

In order to make the purpose, technical solutions and advantages of the technical solutions of the present disclosure clearer, the technical solutions of the embodiments of the present disclosure will be clearly and completely described below with reference to the accompanying figures of specific embodiments of the present disclosure. The same reference numbers in the figures represent the same parts. It should be noted that the described embodiments are some, not all, of the embodiments of the present disclosure. Based on the described embodiments of the present disclosure, all other embodiments obtained by those of ordinary skill in the art without creative efforts fall within the scope of protection of the present disclosure.

Possible implementations within the scope of protection of the present disclosure may have fewer components than the embodiments illustrated in the figures, have other components not illustrated in the figures, different components, differently arranged components or differently connected components, etc. Furthermore, two or more components in the figures may be implemented within a single component, or a single component shown in the figures may be implemented as multiple separate components.

Unless otherwise defined, technical or scientific terms used herein shall have their ordinary meaning as understood by a person of ordinary skill in the art to which this disclosure belongs. The terms “first”, “second” and similar words used in the specification and claims of this disclosure do not indicate any order, quantity or importance, but are only used to distinguish different components. When the number of components is not stated, the number of components can be one or more; Likewise, words such as “a,” “the,” “the,” and similar words do not necessarily indicate a quantitative limitation. Words such as “include” or “comprise” mean that the elements or items appearing before the word include the elements or items listed after the word and their equivalents, without excluding other elements or items. Words such as “installation”, “setting”, “connection” or “connection” are not limited to physical or mechanical installation, setting, and connection, but may include electrical installation, setting, and connection, whether direct or indirect. “Up”, “down”, “left”, “right”, etc. are only used to represent the relative orientation relationship when the device is used or the orientation relationship shown in the figures. When the absolute position of the described object changes, the relative position relationships may also change accordingly.

For ease of explanation, the direction of the rotational axis of the bearing is referred to herein as the axial direction, and the direction perpendicular to the axial direction is referred to as the radial direction. The term “inward” means along towards the inside of the bearing, and conversely, the term “outer” means towards the outside of the bearing. Furthermore, bearings usually include multiple rolling elements, and even if not modified by “plurality”, the rolling elements should be understood as multiple rather than single. Additionally, in different embodiments, the same reference numbers are used to refer to components having the same or similar structure and function.

The present disclosure will now be described with reference to the accompanying figures.

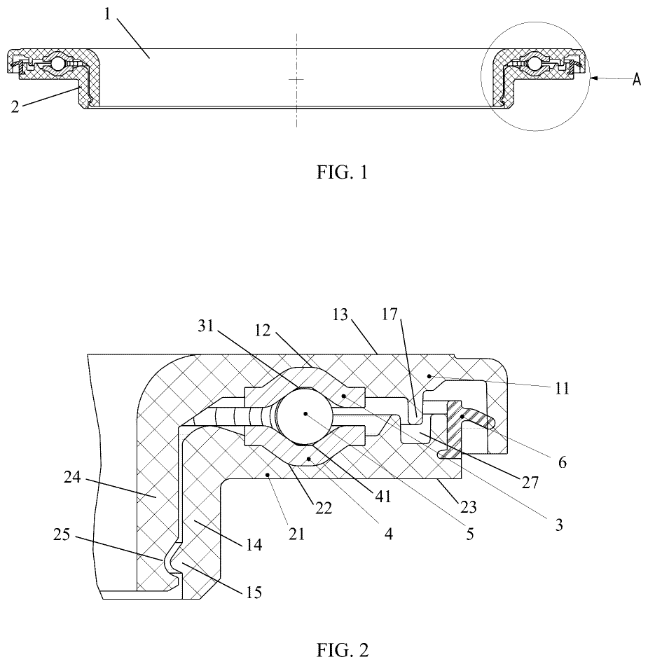

With reference to FIGS. 1 and 2, the bearing comprises: an upper housing 1 having a radial upper flange 11 including an upper recess 12; a lower housing 2 having a radial lower flange 21 comprising a lower recess 22; an upper ring 3 disposed in the upper recess 12 and having an upper raceway 31; a lower ring 4 disposed in the lower recess 22 and having a lower raceway 41; and a rolling element 5 arranged between the upper raceway 31 and the lower raceway 41. It should be understood that in the orientation of the figures, the radial direction is horizontal and the axial direction is vertical.

With this bearing configuration, the upper and lower rings are embedded in the respective upper and lower housings, respectively, which effectively reduces the overall axial height of the bearing, while the rolling elements are placed between the upper and lower rings to realize rotation between the upper and lower housings. Compared with the prior art, the friction torque is reduced and the stiffness is higher, so that capacity for withstanding axial and radial loads can be greatly improved while achieving an axially compact configuration.

It should be understood that although the disclosed embodiment shown in the figures uses balls as the rolling elements, according to other embodiments not shown, rollers or needles or other suitable types of rolling elements may be provided between the upper and lower rings.

In the case where the rolling element 5 is a ball (for example, a steel ball), as shown in the figure, a two-point contact with the upper raceway 31 is formed, with the two contact points being symmetrical with respect to an axis passing through the center of the ball along the axial direction, and a two-point contact with the lower raceway 41 is also formed, with the two contact points being symmetrical with respect to the axis passing through the center of the ball along the axial direction. And further preferably, the two contact points of the ball with the upper raceway 31 and the two contact points of the ball with the lower raceway 41 may be symmetrical with respect to a plane passing through the center of the ball and perpendicular to the axial direction.

As a result, ball-type rolling elements form symmetrical four-point contacts with the upper and lower raceways, which further enhances the bearing's axial and radial load capacity, optimizes the forces applied to the rolling elements, and gives the bearing better stability and longer life.

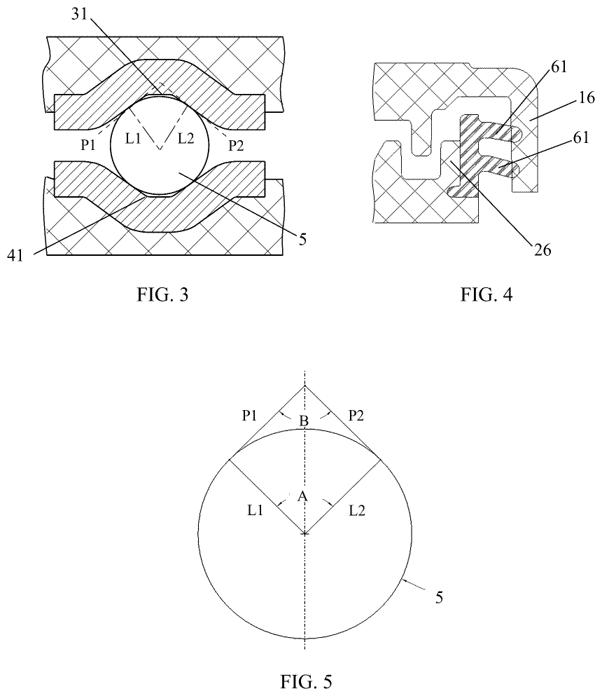

Further preferably, referring to FIG. 3, the included angle (also referred to as contact angle) between the connecting lines L1, L2 (as shown by the dotted lines in FIG. 3) which connect the center of the ball and the two contact points of the ball with the upper raceway 31 may be 90°±30°. Similarly, the included angle between the connecting lines (not shown) which connect the center of the ball and the two contact points of the ball with the lower raceway 41 may be 90°±30°. Through this optimal design of the contact angle, it can be ensured that the ball is in a stable force-applied status and can withstand high load during the operation of the bearing.

Further preferably, referring to FIG. 3, the two surfaces of the upper raceway 31 contacting the ball may be formed as curved surfaces, and the included angle (also called the containment angle) between the tangent planes P1 and P2 (shown as the dotted lines in FIG. 3) respectively passing through the contact points on the two curved surfaces may be 90°±30°. Alternatively, in other embodiments not shown, the two surfaces of the upper raceway 31 contacting the ball may be formed as flat surfaces, and the included angle between the two flat surfaces may be 90°±30°.

Similarly, referring to FIG. 3, two surfaces of the lower raceway 41 contacting the ball are formed as curved surfaces, and the angle between tangent planes (not shown) respectively passing through the contact points on the two curved surfaces can be 90°±30°. Alternatively, in other embodiments not shown, the two surfaces of the lower raceway 41 that contact the ball are formed as flat surfaces, and the angle between the two flat surfaces may be 90°±30°.

Referring to the simplified view of FIG. 5, generally, the sum of the contact angle A and the containment angle B is 180°, and according to a preferred embodiment, the contact angle A and the containment angle B may both be 90°.

By designing the containment angle of upper and lower raceways, the retaining and accommodating performance of upper and lower raceways for the rolling elements is optimized, ensuring that the rolling elements are stably retained and in optimal motion state during the operation of the bearing.

Preferably, in order to further reduce the axial height of the bearing, the present disclosure also proposes a dimensional optimization for the ball-type rolling elements. For example, ratio of the diameter of the ball to the height between the upper surface 13 of the upper housing 1 and the lower surface 23 of the lower housing 2 is 1:5 to 2:3, for example preferably 1:2. For example, for a typical application, the height may be 6.2-6.5 cm, and the diameter of the ball may be no more than 3 cm.

Generally, bearing designs using rolling elements generally require more axial space. In order to achieve a compact layout without sacrificing load capacity, the present disclosure further introduces a “small ball” design to meet the requirement of compact space. At the same time, due to adoption of the above-mentioned optimized raceway and four-point contact design, the present disclosure can further achieve low friction torque, high rigidity and high load capacity.

In addition, the upper and lower housings and the upper and lower rings may be selected and designed according to the scenario in which the bearing is applied.

According to a preferred embodiment of the present disclosure, the upper ring 3 may be a metal ring (such as a steel ring), and the upper housing 1 may be made of plastic material and fixedly connected to the upper ring 3 and/or the lower ring 4 may be a metal ring (such as a steel ring), and the lower housing 2 may be made of plastic material and fixedly connected to the lower ring 4, thereby further ensuring the strength of the bearing while reducing the weight of the bearing.

The fixed connection may be achieved by any suitable means, such as by interference fit, adhesion, welding, riveting, etc. According to a preferred embodiment, after making the upper and lower rings of metal material, the upper and lower housings of plastic material can be molded to the upper and lower rings respectively by injection molding to achieve a more stable connection.

Preferably, referring to FIG. 2, the upper housing 1 further comprises an axial part 14 with a protrusion 15, and the lower housing 2 further comprises an axial part 24 with a recess 25, so that in the assembled state of the bearing, the protrusion 15 is placed in the recess 25 to suppress the relative movement between the upper housing 1 and the lower housing 2 along the axial direction and prevent the upper and lower housings from being separated. It will be appreciated that the protrusion 15 and recess 25 may take any suitable form, for example the protrusion 15 may be a continuous annular flange or discontinuous individual protrusions surrounding the axial part 14, and correspondingly, the recesses 25 may be a continuous annular groove or discontinuous individual concavities surrounding the axial part 24.

According to another preferred embodiment not shown, the axial part of the upper housing 1 may have a recess, and the axial part of the lower housing 2 may have a protrusion, so that in the assembled state of the bearing, the protrusion is also placed in the recess to suppress the relative movement between the upper housing 1 and the lower housing 2 along the axial direction.

Preferably, referring to FIG. 4, the radial upper flange 11 may also have an upper annular wall 16 extending axially downward, and the radial lower flange 21 may also have a lower annular wall 26 extending axially upward. Further, in the embodiment as shown, the lower annular wall 26 may be located radially inwardly of the upper annular wall 16. Alternatively, in a preferred embodiment not shown, the lower annular wall 26 may be located radially outwardly of the upper annular wall 16.

Further preferably, the bearing also comprises a seal 6 disposed between the upper annular wall 16 and the lower annular wall 26. The seal 6 is fixed to one of the upper annular wall 16 and the lower annular wall 26, and in the embodiment shown in the figures, the seal 6 may be molded together with the lower annular wall 26 by injection molding.

The seal 6 may also have at least one sealing lip 61 extending toward and contacting the other one of the upper annular wall 16 and the lower annular wall 26. For example, in the embodiment of FIG. 2, the seal 6 comprises one sealing lip, and in the embodiment of FIG. 4, the seal 6 comprises two sealing lips. Therefore, more sealing lips can be provided as needed.

The above shows an embodiment using a contact seal between the upper housing and the lower housing, but a non-contact seal may be used between the upper housing and the lower housing as needed.

In order to increase the sealing performance, as shown in FIG. 2, an annular flange 17 may be provided on the inner side of the upper housing, and an annular groove 27 may be provided on the inner side of the lower housing, so that the annular flange 17 extends into the annular groove 27 to form a labyrinth sealing structure that prevents contaminants from entering the interior of the bearing.

In summary, the present disclosure adopts an unconventional bearing design, which not only realizes an axially compact bearing structure, without sacrificing load capacity of the bearing, but also provides more optimal force-bearing performance along axial and radial directions.

The exemplary embodiments of the present disclosure have been described in detail above with reference to preferred embodiments. Those skilled in the art can understand that various changes and modifications can be made to the above specific embodiments without departing from the concept of the present disclosure, and various technical features and structures proposed in the present disclosure can be combined in various ways without exceeding the scope of protection of the present disclosure, which is determined by the appended claims.

What is claimed is:

1. A bearing for a vehicle suspension comprising:
an upper housing having a radial upper flange with an upper recess;
a lower housing having a radial lower flange with a lower recess;
an upper ring disposed in the upper recess and having an upper raceway surface;
a lower ring disposed in the lower recess and having a lower raceway surface; and
a plurality of balls disposed between the upper raceway surface and the lower raceway surface,
wherein each of the balls contacts the upper raceway surface at a first point and at a second point,
wherein the first point and second point are angularly spaced by a first angle,
wherein each of the plurality of balls contacts the lower raceway surface at a third point and at a fourth point, and
wherein the third point and fourth point are angularly spaced by a second angle.

2. The bearing according to claim 1,
wherein the first angle is equal to the second angle.

3. The bearing according to claim 2,
wherein the first angle is 90°±30° and/or the second angle is 90°±30°.

4. The bearing according to claim 3,
wherein the first and second points are located on a curved portion of the upper raceway surface.

5. The bearing according to claim 3,
wherein the first and second points are located on a conical portion of the upper raceway surface.

6. The bearing according to claim 3,
wherein a ratio of a diameter of each of the plurality of balls to a distance from an upper surface of the radial upper flange to a lower surface of the radial lower flange upper is from 1:5 to 2:3.

7. The bearing according to claim 3,
wherein the upper housing is made of plastic and the upper ring is made of metal and fixedly connected to the upper housing, and/or
wherein the lower housing is made of plastic and the lower ring is made of metal and fixedly connected to the lower housing.

8. The bearing according to claim 3,
wherein the lower housing further comprises an axial part with a recess, and the upper housing further comprises an axial part with a protrusion extending into the recess of the axial part of the lower housing, or
wherein the upper housing further comprises an axial part with a recess, and the lower housing further comprises an axial part with a protrusion with a protrusion extending into the recess of the axial part of the upper housing.

9. The bearing according to claim 8,
wherein the radial upper flange includes an upper annular wall extending axially downward and the radial lower flange includes a lower annular wall extending axially upward, and
wherein the lower annular wall is located radially inwardly of the upper annular wall or the lower annular wall is located radially outwardly of the upper annular wall.

10. The bearing according to claim 9,
including a seal disposed between the upper annular wall and the lower annular wall, the seal including a seal lip,
wherein the seal is fixed to the upper annular wall and the seal lip extends toward the lower annular wall or the seal is fixed to the lower annular wall and the seal lip extends toward the upper annular wall.

11. The bearing according to claim 9,
wherein a ratio of a diameter of each of the plurality of balls to a distance from an upper surface of the radial upper flange to a lower surface of the radial lower flange upper is from 1:5 to 2:3.

12. The bearing according to claim 11,
wherein an imaginary plane perpendicular to a bearing axis of rotation passes through a center of each of the plurality of balls, and
wherein the upper ring is disposed entirely above the imaginary plane and the lower ring is disposed entirely below the plane.

13. The bearing according to claim 11,
wherein an imaginary plane perpendicular to a bearing axis of rotation passes through a center of each of the plurality of balls, and
wherein the upper raceway surface is disposed entirely above the imaginary plane and the lower raceway surface is disposed entirely below the plane.

14. The bearing according to claim 3,
wherein an imaginary plane perpendicular to a bearing axis of rotation passes through a center of each of the plurality of balls, and
wherein the upper ring is disposed entirely above the imaginary plane and the lower ring is disposed entirely below the plane.

15. The bearing according to claim 3,
wherein an imaginary plane perpendicular to a bearing axis of rotation passes through a center of each of the plurality of balls, and
wherein the upper raceway surface is disposed entirely above the imaginary plane and the lower raceway surface is disposed entirely below the plane.
